(19) United States
(12) Patent Application Publication
(10) Pub. No.: US 2025/0352996 A1
(43) Pub. Date: Nov. 20, 2025

(54) FILTER MODULE FOR A PIPETTE SYSTEM

(71) Applicant: Opentrons LabWorks Inc., Brooklyn, NY (US)

(72) Inventors: Christopher Yarka, Brooklyn, NY (US); Shawn Michael Koop, Cottage Grove, MN (US); Andres Guillermo Calderon, Woodside, NY (US); James Griszbacher, Mount Kisco, NY (US)

(73) Assignee: Opentrons LabWorks Inc., Brooklyn, NY (US)

(21) Appl. No.: 18/667,921

(22) Filed: May 17, 2024

(51) Int. Cl. B01L 3/02

(52) U.S. Cl. CPC B01L 3/021; B01L 2300/0681

(57) ABSTRACT

A filter system for an enclosed pipette system within a housing including a body having a first surface and a second surface opposite the first surface, the second surface being configured to engage with the housing of the enclosed pipette system. The body includes a first opening, one or more second openings in an external surface of the body, and a plenum defining a conduit between the one or more second openings and the first opening. The filter system further includes a mounting system positioned on the second surface and includes a plurality of latches configured to releasably secure the body to the housing. A filter component is positioned within the plenum, and an air movement system is configured to force air through the plenum to the first opening. An ultraviolet source is positioned on the bottom surface and configured to project ultraviolet light into the housing.

### TECHNICAL FIELD

The present disclosure relates generally to filters for liquid handling systems. Specifically, the present disclosure relates to systems and methods for providing purified air to an enclosure of a pipette system.

### BACKGROUND

A liquid handling system such as a pipette system may include robotic elements and a number of selectively couplable pipettes that may be coupled to a moveable stage. The moveable stage assists in moving and precisely placing the pipettes above receptacles such as reaction containers or devices used to react liquid solutions dispensed by the pipettes. The pipette system includes a robot that may pick up a tip and attach the tip to a pipette. With a tip attached, the pipette system can aspirate and dispense liquids using the pipette. A pipette robot can include an XYZ gantry, a pipette which is attached to the XYZ gantry, and a deck upon which labware can be situated. Liquid access by the pipette robot can involve the robot moving the XYZ gantry about a rigid frame. The pipette robot can perform various operations with respect to the labware, for instance accessing (e.g., aspirating and dispensing) blood and other liquids held by the labware. For various applications, there can be call that the pipette robot achieve high accuracy (e.g., sub-millimeter accuracy) when performing such liquid access.

In an illustrative embodiment, the pipettes, receptacles, and/or devices used to react the liquid solutions may be located within an enclosed space in which the reaction may be isolated from any outside environment in order to ensure that no other objects may interrupt the processes of the liquid handling system and/or the reactions taking place within the enclosed space. The environment within the enclosure may be controlled to prevent ingress of foreign material or debris and also to prevent contamination. Accordingly, a system for providing the enclosure with a clean and contaminant free environment is needed to ensure accuracy of results produced by the pipette system.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a perspective view of a liquid handling system with a filter module, according to at least one embodiment.

FIG. 2 illustrates a bottom perspective view of the filter module of FIG. 1, according to at least one embodiment.

FIG. 3 illustrates a bottom view of the filter module of FIG. 1, according to at least one embodiment.

FIG. 4 illustrates a section view of the filter module of FIG. 1 depicting a section along a length of the filter module, according to at least one embodiment.

FIG. 5 illustrates a top perspective view of the filter module of FIG. 1 with a top cover of the filter module removed, according to at least one embodiment.

FIG. 6 illustrates a top view of the filter module of FIG. 5 with the top cover of the filter module removed, according to at least one embodiment.

FIG. 7 illustrates a bottom perspective view of the filter module of FIG. 1 with a filter element removed, according to at least one embodiment.

FIG. 8 illustrates a bottom perspective view of the filter module of FIG. 7 with a bottom cover removed, according to at least one embodiment.

FIG. 9 illustrates a schematic of a filter module for providing power to perform a filtering operation, according to at least one embodiment.

### DETAILED DESCRIPTION

This disclosure describes systems and methods for filtering air and environment of an enclosure for a pipette system used for handling liquids and providing control and distribution of liquid across movable stages. Though described herein with respect to an enclosure of a pipette system, the filter system and associated components may be implemented for control and filtering of environmental conditions within other types of enclosures and controlled environments.

According to various embodiments, there are provided systems and methods applicable, for instance, to pipette systems including pipette robots. The pipette system described herein may include a movable stage and may also include a gantry and other components for dispensing liquids. The movable stage may include a moveable pipette mount coupled to the movable stage and moveable along a length of the movable stage.

The pipette system may further include a display device, a processor communicatively coupled to the display device, and a non-transitory computer-readable media storing instructions that, when executed by the processor, causes the processor to perform operations. The operations may include presenting instruction on the display device communicatively coupled to the pipette system, the instruction presenting at least one step used to install and remove a first pipette, a second pipette, and a third pipette to and from the first moveable pipette mount and the second moveable pipette mount of the movable stage.

This disclosure describes a filter system for an enclosure of a pipette system such as one equipped with a robotic pipette system including a movable stage with a moveable pipette mount coupled to the movable stage and moveable along a length of the movable stage. The moveable pipette mount may move in a direction that places pipette(s) coupled thereto closer to receptacles, devices used to react the liquid solutions, or other elements located within an enclosed space of a liquid handling system and located on a deck housed within the and enclosed space of the liquid handling system. The moveable pipette mount may include a mounting header, a header fastener, and a mounting base removably coupled to the mounting header via the header fastener.

The filter system is designed to couple with a housing or enclosure of the pipette system. In this manner, a panel of the enclosure of the pipette system may be removed and the open space left by the removed panel may be covered by the filter system to provide filtered air as well as ultraviolet filtration for preventing ingress of contaminants into the enclosure. The filter system includes a body with a top surface and a bottom surface configured to engage with the housing of the pipette system. The body has a first opening that, when the filter system is coupled to the enclosure, provides an air inlet into the enclosure. The body further has one or more second openings that intake air from a surrounding environment into the filter system for filtration and/or treatment before being injected into the enclosure through the first opening. The body defines a plenum providing a conduit between the one or more second openings and the first opening. The plenum provides for handling of air before the air is injected or forced into the enclosure. The plenum may include one or more filter components and/or other components for treatment or handling of the air. The filter system may provide the air into the enclosure to further provide positive pressure within the enclosure of the pipette system and thereby prevent ingress of air or contaminants into the enclosure. The positive pressure within the enclosure relative to the surrounding environment ensures that any openings or leaks in the enclosure do not provide for ingress of air or contaminants.

The filter system connects to the enclosure with a mounting system positioned on the bottom surface that has a plurality of latches configured to releasably secure with the enclosure to releasably secure the body to the enclosure. The mounting system provides for releasable connection to the enclosure and may provide for attachment to an enclosure without requiring a retrofit or latch component added to the enclosure. In an illustrative embodiment, the mounting system may include push-pin mounts that engage with the frame of the enclosure surrounding the opening where the filter system is connected. The push-pin mounts may include pins that are captured in receptacles protruding from the bottom of the filter system and that, when extended, latch underneath the frame structure and/or into holes or grooves in the frame components. A gasket positioned on the bottom surface of the filter system provides for an airtight seal between the filter system and the enclosure.

The filter system included within the plenum includes an air filter such as a high efficiency particle air (HEPA) filter. The filter system also includes an air movement system contained within the body and configured to force air through the plenum from the one or more second openings to the first opening. The air movement system provides for the positive pressure within the enclosure described above. The plenum may also contain a pre-filter chamber with a first filter component in addition to the air filter. The pre-filter may be positioned at a pre-filter chamber of the plenum that may be adjacent or included with the air movement system. In an illustrative embodiment, the air movement system may include a fan that drives air through the plenum and into the enclosure. The fan may be positioned within the pre-filter chamber or downstream of the pre-filter chamber such that a first filter element removes or prevents ingress of particles exceeding a first size and the second filter further filters the air to restrict particles entering the enclosure to a second size. The stages of filters may prevent the air filter from becoming clogged prematurely and therefore may extend the life of the air filter.

The system may also include an ultraviolet source positioned on the bottom surface and configured to project ultraviolet light into the housing of the enclosed pipette system. The ultraviolet source may be used to further control contaminants or foreign objects that may enter into the enclosure. In an illustrative embodiment, the ultraviolet source may be used to eliminate or reduce biological contaminants, including those that may pass through the filters of the filter system. The ultraviolet source may include ultraviolet light bulbs that may be within the body of the filter system, in an illustrative embodiment, the ultraviolet light bulbs may have a length that is aligned along a length of the body of the filter system and/or along the plenum such that the ultraviolet light may be contained within the body. The ultraviolet source may also include ultraviolet light bulbs at the bottom surface of the filter system to provide ultraviolet light into the enclosure. The ultraviolet light bulbs may be fit within a reflector to direct ultraviolet light into a treatment space. In an illustrative embodiment, the reflectors and/or ultraviolet light bulbs may be recessed in the bottom surface of the filter system so as to not protrude and to protect the light bulbs during installation of the filter system. The reflector may direct light from the bulb into the enclosure to increase the efficiency of the ultraviolet lights.

The filter system may be controlled by an on-board circuit board and/or computing device including a processor and non-transitory computer readable medium having instructions thereon configured to control operation of the air movement system and/or ultraviolet source. In an illustrative embodiment, the control system of the filter system may be configured to engage a timer or to run operation of one or more components of the filter system for a predetermined period of time, or at a predetermined interval. In an illustrative embodiment, the ultraviolet source may be engaged for a period of time such as X minutes at a startup of the pipette system. The air movement system may be configured to run for Y minutes after startup of the machine. In an illustrative embodiment, a user interface of the filter system may be used to control operations of the components through buttons, touch-screen interfaces, or other user inputs.

The operation of the filter system may also be controlled by a computing device of the pipette system. In an illustrative embodiment, the computing device may connect through a communication connection to the filter system such as a wired or wireless connections and may provide for control of the air movement system and/or ultraviolet light based on the operation of the pipette system. For instance, the air movement system may be turned on and/or off based on the operation of the pipette system, such as to engage the air system whenever the pipette robot is performing an operation and/or for a predetermined period of time before and/or after such an operation. In an embodiment, the operation of the filter system may be controlled by the pipette system such that the filter system 104 runs or operates (e.g., the air movement system or ultraviolet source) at particular times, intervals, or during particular operations performed by the pipette system.

The filter system may include a switch component to prevent accidental operation or engagement of the systems when not coupled with the enclosure. In an illustrative embodiment, the filter system may include a magnetic switch at the bottom surface that detects a magnet positioned on a frame of the enclosure and/or to detect the metallic frame of the enclosure in proximity to the magnetic sensor. The magnetic sensor may prevent operation of the systems within the filter system until the sensor detects the presence and/or coupling with the enclosure. Though a magnetic sensor is described, other sensors and systems for detecting coupling with the enclosure may be implemented to engage and prevent operation of the filter system based on whether the filter system is connected to the enclosure.

The filter system may be lifted into place on the enclosure by a human, robot, or other system. In an illustrative embodiment, the one or more second openings in the body of the filter system may provide for mounting points for connecting lifting components. In an illustrative embodiment, the one or more openings may include threaded connections for receiving a handle, lifting point, eyebolt, and/or other types of connections for receiving a handle or other lifting component that may be removably connected to the filter system. In this manner, the filter system may be lifted into place and the lifting components may be removed to provide the openings for air intake into the body. The lifting components provide for secure positioning of the filter system onto the top of the enclosure.

In an illustrative embodiment, the filter system described herein provides for air and ultraviolet filtration for a housing of an enclosed pipette system. The filter system includes a body defining a top surface, a bottom surface configured to engage with the housing of the enclosed pipette system and including a first opening, one or more second openings in an external surface of the body, and a plenum defining a conduit between the one or more second openings and the first opening. The filter system may also include a mounting system positioned on the bottom surface and may include a plurality of latches configured to releasably secure with the housing to releasably secure the body to the housing. The system may also include a filter component positioned within the plenum. The system may also include an air movement system contained within the body and configured to force air through the plenum from the one or more second openings to the first opening. The system may also include an ultraviolet source positioned on the bottom surface and configured to project ultraviolet light into the housing of the enclosed pipette system.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

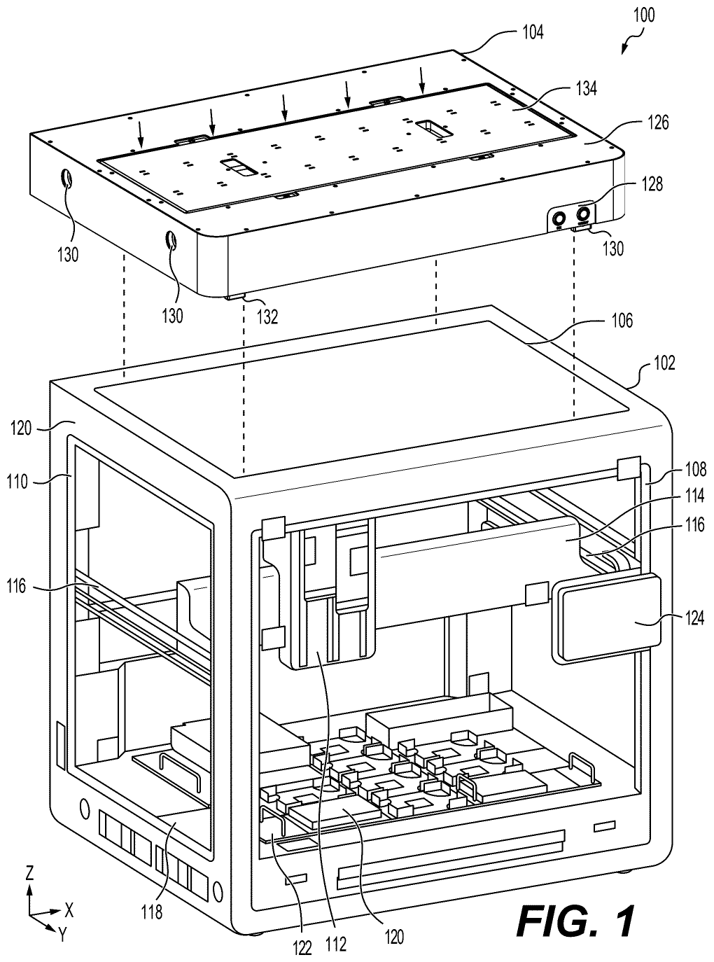

FIG. 1 illustrates a perspective view of a liquid handling system 100 with a filter system 104, according to at least one embodiment. As mentioned herein, the liquid handling system 100 may further include liquid handling system hardware. Some of those elements are depicted in FIG. 1. In an embodiment, the liquid handling system 100 may include a housing 102. The housing 102 may include one or more sides or walls, and as depicted in FIG. 1, including wall 106, wall 108, and wall 110. The housing may include a top side, four vertically positioned side walls, and a bottom side coupled to one another to form a generally box-like architecture to house and accommodate for a number of other liquid handling system hardware. In an embodiment, one or more of the top side, the side walls, and the bottom side may include a transparent portion such as windows to allow for a user to view into the internal portion of the housing 102. The wall 106, wall 108, and/or wall 110 (among the other walls) may be removable from the housing 102. In an embodiment, the wall 106 may be removed such that an open side of the housing 102 is presented for the filter system 104 to engage with.

Housed within the housing 102 may be the movable stage 112. The movable stage 112 may be mechanically coupled to an x-axis movable truss 114 that may cause the movable stage 112 in the x-direction. Further, the movable stage 112 may be mechanically coupled to a first y-axis movable truss 116 and a second y-axis movable truss 116 that may cause the movable stage 112 in the y-direction. The x-axis movable truss 114 and the y-axis movable truss 116 may be driven by one or more motors that may be actuated through instructions received from an instructing device (e.g., computing device). The instructions used to actuate the motors may cause the movable stage 112 to be moved to a digitally addressable location within the interior of the housing 102.

The housing 102 may further house a deck 118. The deck 118 may be located at the bottom of the housing 102 and may retain one or more cradle devices 120. The cradle devices 120 may be removably or selectively coupled to the deck 118 and may be used to retain one or more modules 122 that may be coupled to the cradle devices 120 and used to process the liquids dispensed by the liquid handling system 100. In an embodiment, the modules 122 may include, for instance, a temperature deck, a heat shaker, a thermocycler, a heating device, a cooling device, a vacuum pump, a centrifuge, a liquid handler, a tube handling device, a sealing device, an unsealing device, a magnetic device, other modules, and combinations thereof. In connection with the instructions used to actuate the motors associated with the x-axis movable truss 114 and the y-axis movable truss 116, these instructions may cause the movable stage 112 to be moved to a digitally addressable location within the interior of the housing 102 including an area or portion of or a position on the modules 122 such that pipettes may dispense fluids onto or into the modules 122.

As depicted in FIG. 1, the liquid handling system 100 may include a user interface (UI 124). In an embodiment and as depicted in FIG. 1, the UI 124 may be a touchscreen that may detect touch input from a user and includes both an input device (a touch panel) and an output device (a visual display) where the touch panel is layered on the top of the electronic visual display. The instructions and prompts described herein may be presented to the user of the liquid handling system 100 via this or another UI 124. The UI 124 may be communicatively coupled to the instructing device and/or any of the elements within the housing 102. This allows the instructing device and/or any of the elements within the housing 102 to present the instructions and prompts described herein via the UI 124 and to allow a user to enter information via interactive elements of the UI 124. Although depicted and described as a touchscreen, the UI 124 may include any input and output devices such as a display device, a printer, an audio speaker, a haptic device, a heads-up display, a keyboard, a mouse, a touchpad, a trackpad, an accelerometer, a gyroscope, a proximity sensor, a thermometer, a virtual reality system, an augmented reality system, a joystick, a gamepad, a paddle, a camera, a microphone, other input and/or output devices, and combinations thereof.

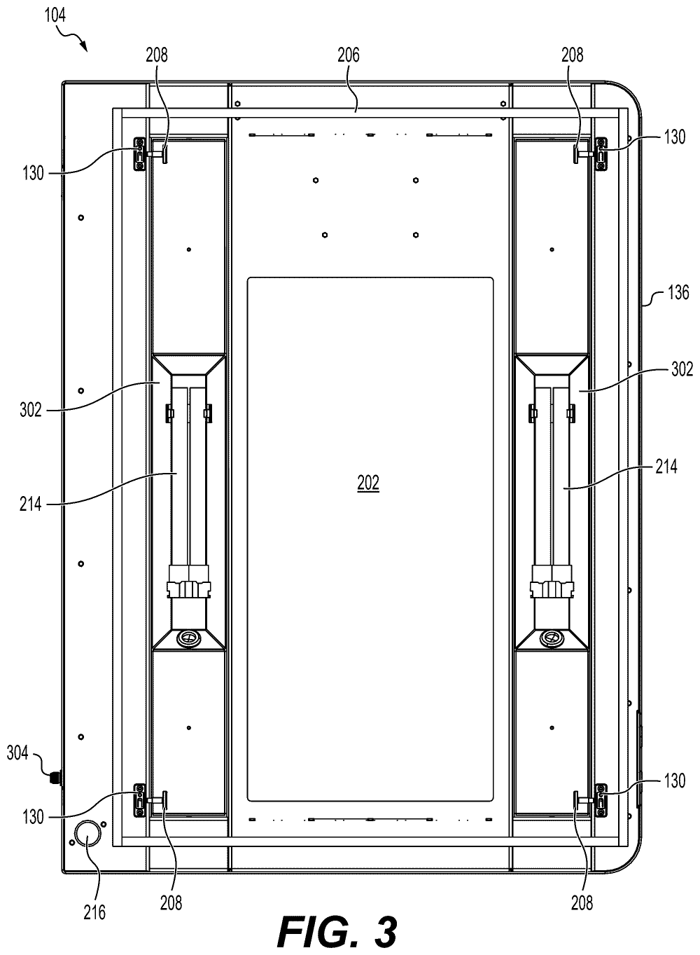

In an embodiment, operation of the filter system 104 may also be controlled by a computing device of the liquid handling system 100. The computing device may connect the filter system 104 through a communication connection (e.g., connection 304 of FIG. 3) to the filter system 104 such as a wired or wireless connections and may provide for control of the air movement system and/or ultraviolet light based on the operation of the liquid handling system 100. For instance, the air movement system may be turned on and/or off based on the operation of the liquid handling system 100, such as to engage the air system whenever the robot is performing an operation and/or for a predetermined period of time before and/or after such an operation. In an embodiment, the operation of the filter system may be controlled by the liquid handling system 100 such that the filter system 104 runs or operates (e.g., the air movement system or ultraviolet source) at particular times, intervals, or during particular operations performed by the liquid handling system 100.

In an embodiment, operation of the filter system 104 may be controlled by a computing device connected to the liquid handling system 100. The computing device may be communicably coupled with the liquid handling system and may include a user interface to display information related to operation of the liquid handling system 100 as well as the filter system 104. The computing device may be used to control the filter system 104 based on inputs received through the user interface and/or based on operations performed by the liquid handling system 100.

The filter system 104 is shown prior to installation on the housing 102. The filter system 104 includes a body 126 that includes components for operation of the filter system as well as for connection to the housing 102. The filter system 104 is designed to couple with the housing 102 and specifically with a frame of the housing 102 after the wall 106 is removed from the housing 102. The wall 106 is removed and the open space left by the wall 106 may be covered by the filter system 104 to provide filtered air as well as ultraviolet filtration for preventing ingress of contaminants into the housing 102. The filter system 104 may provide the air into the housing 102 to further provide positive pressure within the housing 102 of the liquid handling system 100 and thereby prevent ingress of air or contaminants into the housing 102. The positive pressure within the housing 102 relative to the surrounding environment ensures that any openings or leaks in the housing do not provide for ingress of air or contaminants.

The filter system 104 may be formed of a metal such as sheet aluminum or steel or other rigid materials. The body may comprise multiple components assembled together through fasteners. The filter system 104 may be formed of metals, plastic, composites, or other such materials.

The filter system 104 includes a user interface 128 for providing power to an air movement system (not shown in FIG. 1) and an ultraviolet source (not shown in FIG. 1). The user interface 128 provides buttons for interacting with the systems of the filter system 104. Though depicted with buttons, the user interface may include other types of user interfaces including a display device such as a touchscreen, a keyboard, a mouse, a touchpad, a trackpad, a proximity sensor, a joystick, a gamepad, a paddle, a camera, a microphone, other input and/or output devices, and combinations thereof. The user interface 128 may provide for interactions to enable or disable operations of the filter system 104. In an embodiment, the user interface 128 may communicate with a computing device and/or hardware circuit, microprocessor, or other such device for controlling operations of the systems within the filter system 104.

The filter system 104 includes a body with a first surface (i.e., the top surface) and a second surface (i.e., the bottom surface) configured to engage with the housing 102. The filter system 104 has a first opening (not shown in FIG. 1) that, when the filter system 104 is coupled to the housing 102, provides an air inlet into the housing 102 through the opening created when the wall 106 is removed. The filter system 104 further has second openings 130 that intake air from a surrounding environment into the filter system 104 for filtration and/or treatment before being injected into the housing 102 through the first opening. Though shown and described with multiple second openings 130, the filter system 104 may have one second opening or more than one second openings 130, which may further have different shapes and/or configurations.

The second openings 130 include threaded connections for receiving a lifting component, handle, and/or other types of connections for receiving a handle or other lifting component that may be removably connected to the filter system 104. In an embodiment, the second openings 130 may include other types of interfaces for securing a lifting component or other structural component for positioning the filter system 104 on top of the housing 102. In this manner, the filter system 104 may be lifted into place on the housing 102 and the lifting components may be removed to provide openings for air intake into the filter system 104. The lifting components provide for secure positioning of the filter system 104 onto the top of the housing 102. In an embodiment, the second openings 130 may be covered or plugged with a cap after installation of the filter system 104. In such an example, the air intake into the filter system 104 may be through gaps and/or seams in the body of the filter system 104. In an embodiment, the second openings 130 may have a cap inserted and the primary air intake into the filter system 104 may be through the gaps around the access panel 134, as depicted by the arrows of FIG. 1. In an embodiment, other seams or gaps in the body of the filter system 104 may also provide for air intake into the plenum contained within the filter system 104 before passing through a filter element and into the housing 102.

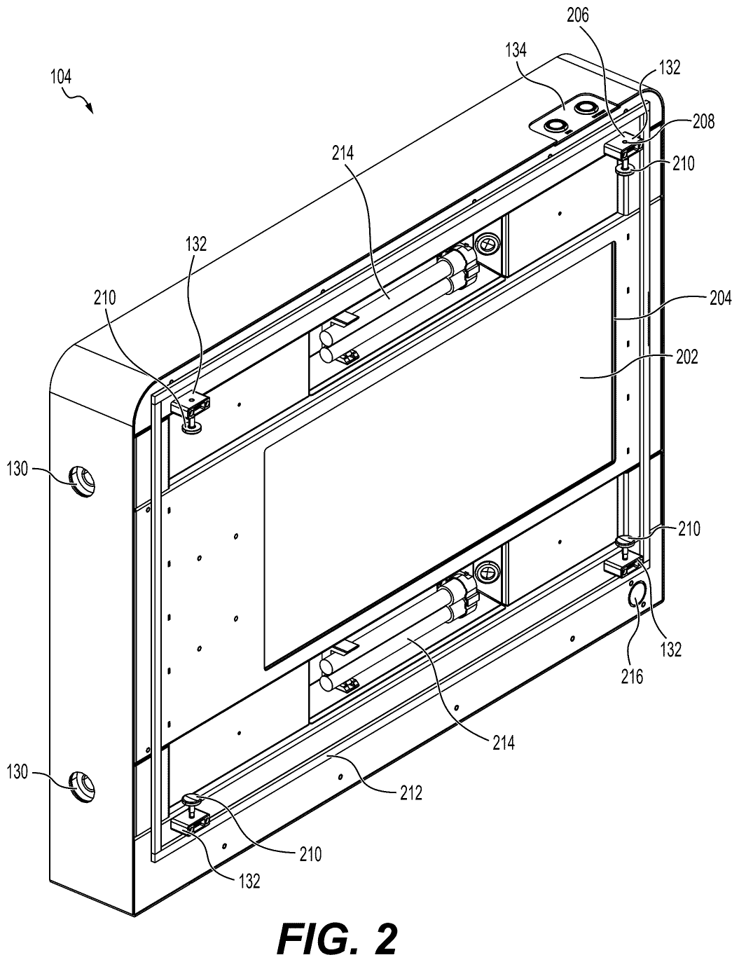

The filter system 104 connects to the housing 102 with a mounting system 132 positioned on the bottom surface that has a plurality of latches configured to releasably secure with the housing 102 to releasably secure the filter system 104 to the housing 102. The mounting system 132 provides for releasable connection to the housing 102 and may provide for attachment to a housing 102 without requiring a retrofit or latch component added to the housing 102. In an embodiment, the mounting system 132 may include push-pin mounts that engage with the frame of the housing 102 surrounding the opening where the filter system 104 is connected. The push-pin mounts may include pins that are captured in receptacles protruding from the bottom of the filter system 104 and that, when extended, latch underneath the frame structure and/or into holes or grooves in the frame components. A gasket positioned on the bottom surface of the filter system 104 provides for an airtight seal between the filter system 104 and the housing 102. Additional details of the mounting system and bottom of the filter system are shown and described with respect to FIG. 2.

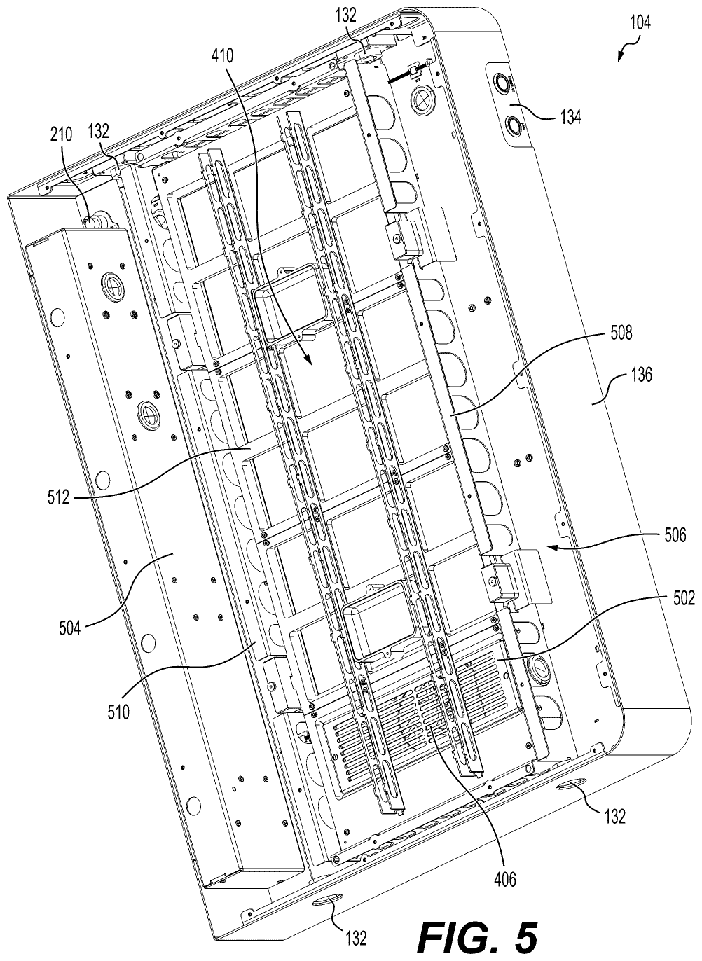

The filter system 104 may further include an access panel 134 that provides access into the interior of the body 126, such as for service and/or replace filter components within the body 126. The access panel 134 is depicted in FIG. 1 as covering a portion of the top surface of the filter system 104. In an embodiment, such as shown in FIG. 5, the access panel 134 may cover an entire upper surface of the filter system 104 such that the entire top surface may be removed to provide access into the interior of the filter system 104. As described previously, the access panel 134 may provide air intake into the filter system 104 through one or more gaps around the perimeter of the access panel 134 and/or through one or more openings defined in the access panel 134. In an embodiment, the body of the filter system 104 may have one or more holes defined therein for air intake into the inner portion (e.g., the plenum described herein) for filtration before passing into the housing 102.

FIGS. 2 and 3 illustrate bottom perspective views of the filter system 104 of FIG. 1, according to at least one embodiment. The filter system 104 is shown with the mounting system 132, second openings 130, and user interface 128 as described with respect to FIG. 1. Additionally, the mounting system 132 is shown in further detail.

Turning now to FIG. 2, the bottom surface of the filter system 104 is shown with a filter element 202 visible through a first opening 204 that defines a passage for air through the filter system 104. The filter element 202 includes a particulate filter or other such system for filtering air that passes through the filter system 104. The filter element 202 may include a high efficiency particulate air (HEPA) filter. The filter element 202 may be held in place by the bottom surface of the body of the filter system 104. In an embodiment, the first opening 204 may be smaller (e.g., in perimeter) than a perimeter of the filter element 202. In an embodiment, the open area of the first opening 204 is smaller than a surface area of the filter element 202. In an embodiment, the filter element 202 may include and/or be replaced with a system that reduces static or dissipates static charge in the enclosure. The system may include an ionizer or other such system to dissipate static charge on elements of the filter system and/or liquid handling system 100.

The mounting system 132 is shown with a receptacle 206 that defines a passage 208 for holding a push pin 210. The push pin 210 is shown in a first position, a retracted position. The push pin 210 can be pushed forward by pressing on the end of the push pin 210. By pushing on the plunger or end of the push pin 210, the first end of the push pin 210 extends from the passage 208 in a first direction (parallel with and aligned with the passage 208) and protrudes from the receptacle 206. When the filter system 104 is positioned on the housing 102, the receptacle 206 of the mounting system 132 extends into the opening on the top of the housing 102. The receptacle 206 aligns the push pin 210 to interact with the frame of the housing when the push pin 210 extends through the passage 208. The push pin 210 therefore secures against the frame of the housing 102. In an embodiment, the push pin 210 may extend into a passage or hole of the frame. In an embodiment, the push pin 210 may extend and secure under a lip of the frame to secure the filter system 104 against the housing 102.

Around the bottom surface of the filter system 104 is a gasket 212. The gasket 212 is shown at or near the perimeter of the bottom surface. In an embodiment, the gasket may be at or away from the edge of the bottom surface and defines an area that includes the mounting system 132 and is shaped and configured to mate against an upper surface of the housing 102 to form an airtight seal between the housing 102 and the filter system 104. The gasket 212 is formed of an airtight or nearly airtight material such as a rubber or plastic, or other compressible media that, when sandwiched between the housing 102 and the filter system 104, forms an airtight seal between the two.

The filter system 104 may also include ultraviolet sources 214. The ultraviolet sources 214 are depicted as ultraviolet light bulbs recessed within the body of the filter system 104. The ultraviolet light bulbs may include a bent or u-shaped bulb for ease of installation. For instance, the bent shaped bulb may be easily screwed in at a single receptacle and not require fitting into two separate electrical connections at opposite ends of the bulb. The reflective surface 302 may ensure that the ultraviolet bulb may provide coverage of the entire enclosure without requiring the bulb to run the full length of the filter system 104. In some examples, a beam or bar-shaped bulb may be used. In an embodiment, any suitable ultraviolet light bulb shape may be used. The ultraviolet light bulbs are recessed within the body, e.g., within cavities formed in the bottom surface of the filter system 104. The recessed ultraviolet light bulbs are protected from damage by being recessed within the cavities of the filter system 104. In this manner, when the filter system 104 is moved and/or secured against the housing, the light bulbs are protected from damage or breaking.

The ultraviolet source also includes a reflective surface 302 (shown in FIG. 3) to reflect ultraviolet light produced by the ultraviolet light bulb back into the housing 102. The reflective surface 302 may have a parabolic, hyperbolic, or other curved shape to reflect light from the ultraviolet source 214 out into the enclosure. The use of the reflective surface 302 provides for scattering of the reflected ultraviolet light that ensures coverage of the entire enclosure. At ends of the reflective surface 302, end reflectors may be positioned at an angle to further reflect the ultraviolet light outwards and away from the bulb to ensure coverage of the entire enclosure. The ultraviolet source 214 is positioned on the bottom surface and configured to project ultraviolet light into the housing 102. The ultraviolet source 214 may be used to control contaminants or foreign objects that may enter into the enclosure. In an embodiment, the ultraviolet source 214 may be used to eliminate or reduce biological contaminants, including those that may pass through the filters of the filter system 104.

In an embodiment, the ultraviolet source 214 may be replaced with a movable LED for disinfecting the enclosure. In an embodiment, the LED may include an ultraviolet-C range of light in a range between 200 nm and 280 nm. The LED may be used to disinfect the enclosure. In an embodiment, the LED and/or the ultraviolet source 214 may be moved on a track or gantry system to further ensure the enclosure is illuminated and that every surface of the enclosure is treated by the light from the ultraviolet source 214.

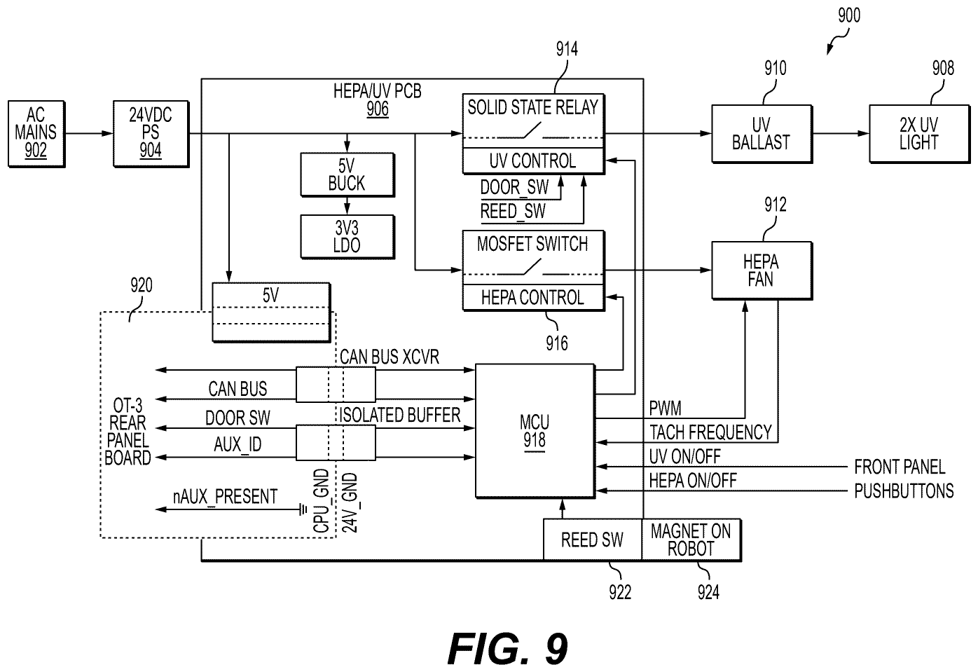

The filter system 104 further includes a sensing system 216 for sensing connection and/or installation of the filter system 104 on the housing 102. The sensing system 216 may include a proximity sensor, button sensor, magnetic reed switch, or other such sensor capable of detecting when the filter system 104 is positioned on the housing 102. For instance, the magnetic sensor may interact with a frame and/or magnet placed on the housing 102. The sensing system 216 may be used to interrupt and/or prevent operation of the filter system 104 unless the filter system 104 is installed on the housing 102. As shown in FIG. 9, the magnetic switch may be used to interrupt the power to the system components.

The filter system 104 further includes a communication connection 304 for providing a data and/or electrical connection to one or more other systems. The communication connection 304 may provide for data to be exchanged between another system such as the housing 102 and/or aa computing device. In some examples, the communication connection 304 may enable the housing 102 and/or other computing device to control one or more operations of and/or provide power for operations of the filter system 104.

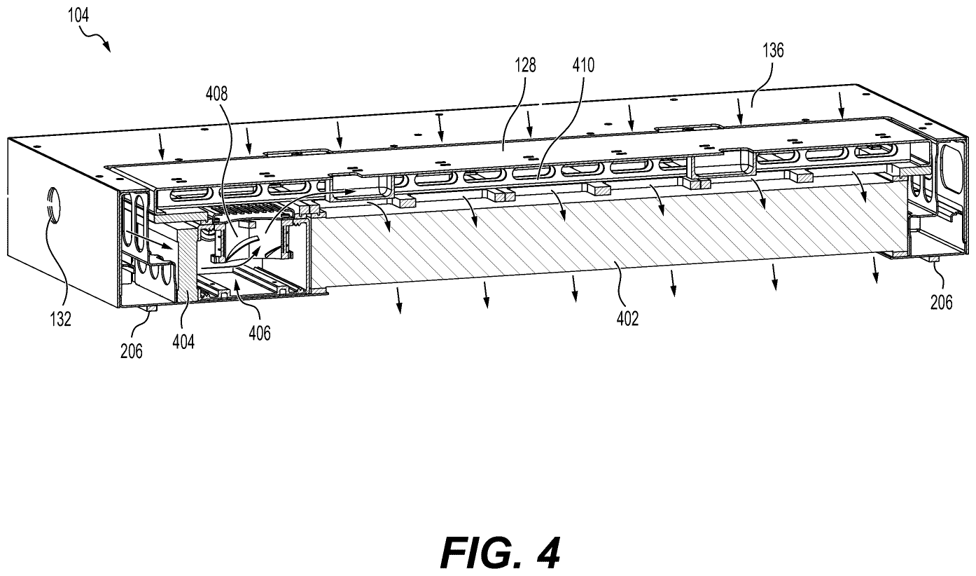

FIG. 4 illustrates a section view of the filter system 104 of FIG. 1 depicting a section along a length of the filter system, according to at least one embodiment. The section view is taken along a length of the filter system 104. The filter system 104 is shown and illustrates a flow direction for air through the filter system 104 to reach a filter 402 and pass into the housing 102. The air passes through one or more openings in the body of the filter system 104, such as the gaps or openings described with respect to the access panel 134, and into an internal section of the body of the filter system 104. In an embodiment, the air may pass through a pre-filter 404 and into a pre-filter chamber 406. The body of the filter system 104 defines a plenum including the pre-filter chamber 406 and into the filter 402. The pre-filter 404 may be positioned at or within the pre-filter chamber 406 that may be adjacent or included with the air movement system 408. In an embodiment, the air movement system 408 may include a fan or other component that drives air through a plenum 410 and into the housing 102 after passing through the filter 402. The air movement system 408 may be positioned within the pre-filter chamber 406 or downstream of the pre-filter chamber 406 such that the pre-filter 404 removes or prevents ingress of particles exceeding a first size and the filter 402 further filters the air to restrict particles entering the housing 102 to a second size. The stages of filters may prevent the air filter from becoming clogged prematurely and therefore may extend the life of the filter 402.

In an embodiment, the filter system 104 includes a pressure sensor positioned within the plenum, for example in the plenum between the pre-filter 404 and the filter 402 such that the pressure within the body may be monitored. When the filter 402 begins to clog, the pressure within the body increases and the filter system 104 (e.g., through a computing device) generates a notification that the filter 402 and/or the pre-filter 404 should be replaced. The pressure may be monitored over time to provide a real-time evaluation of the life of the filter that may be presented through a user interface. For instance, the pressure may be measured and compared against a predetermined threshold (e.g., a pressure determined when the filter 402 is dirty) and the life of the filter may be estimated as a percentage or fraction of the current pressure compared against the threshold. For instance, the life of the filter 402 may be determined to have 10% life remaining when the pressure level reaches 90% of the threshold pressure level.

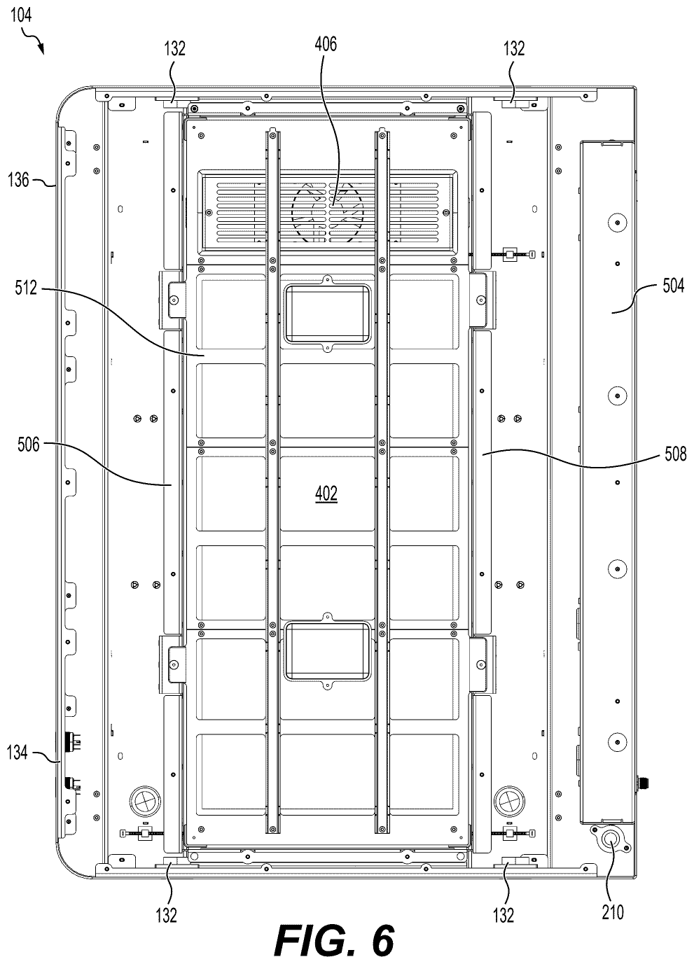

FIGS. 5 and 6 illustrate a top view of the filter system 104 of FIG. 1 with a top cover of the filter system 104 removed, according to at least one embodiment. The top surface of the filter system 104 may be removed to provide access to the interior of the filter system 104 including into a plenum defined into multiple sections as well as a pre-filter chamber 502. The internal components of the filter system 104 define a conduit or air plenum that separates air as it passes into the filter system 104 through one or more openings (such as at the access panel 134), into an internal plenum having first portion 504 and second portion 506 and through the pre-filter and into the pre-filter chamber 502 then pass through the plenum 410 to the filter 402. The internal components include walls 508 and 508 that separate air pre-filter and post-filter and prevents air driven by the air movement system 408 from flowing back into the air plenum. This separation and the resulting direction provided to the forced air from the air movement system 408 enables the filter system 104 to provide positive pressure into the housing 102.

The internal components include a structure 512 that supports the filter element 202 and holds it into place during operation of the filter system 104. The structure 512 includes webbing or stretchers that may be used to form a cavity at an entrance to the filter element 202 to enable the air to flow through the entire surface of the filter element 202 after being forced through the air movement system 408.

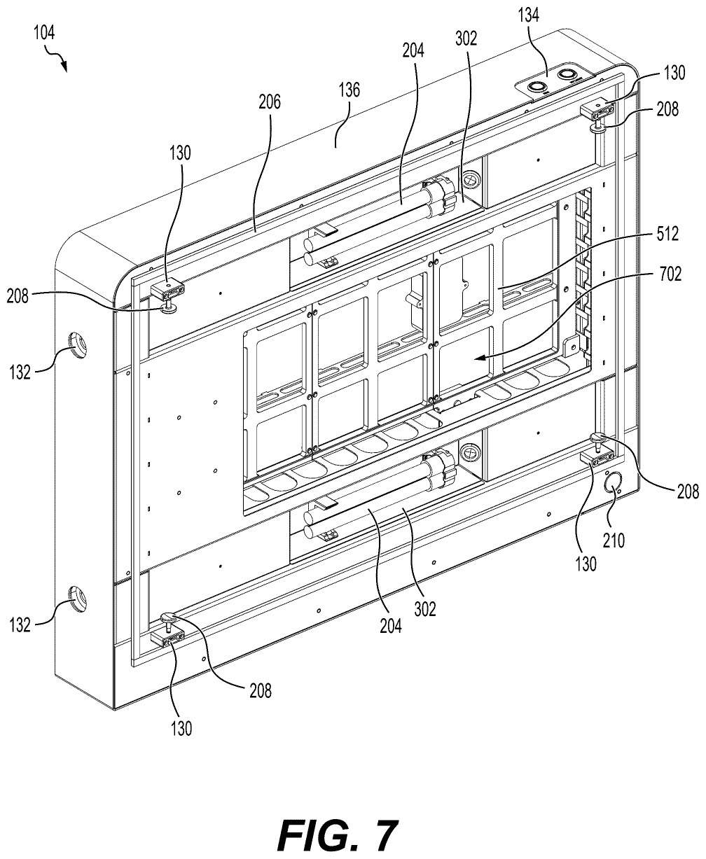

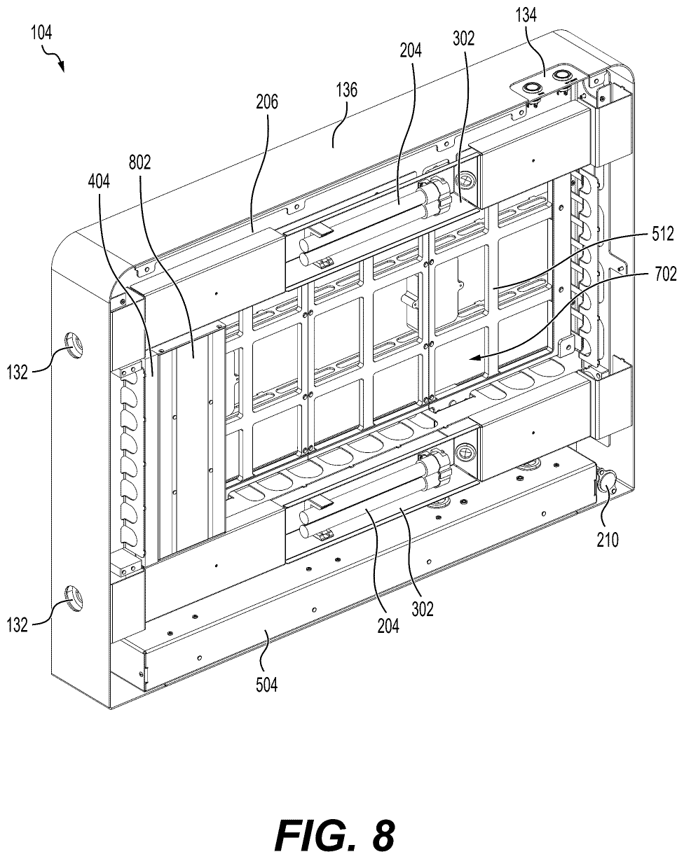

FIGS. 7 and 8 illustrates bottom views of the filter system 104 of FIG. 1 with a filter element 202 removed, according to at least one embodiment. The filter element 202 may not be implemented in the filter system 104 for some implementations or uses. In an embodiment, the filter element 202 may be replaced with. Accordingly, the filter system 104 provides for a cavity 702 that aligns with an entrance into the housing 102. The cavity 702 may be shaped and sized to receive a standard size air filter or other air treatment component or system. The pre-filter 404 and housing 802 for the pre-filter chamber are enclosed within the body of the filter system 104.

FIG. 9 illustrates a schematic 900 of a filter system such as the filter system 104 for providing power to perform a filtering operation, according to at least one embodiment. The schematic 900 includes an alternating current source 902 such as a wired connection that may be provided through a wall outlet or other power outlet. The alternating current source 902 may provide the power to a direct current voltage system 904 that receives the alternating current input and outputs the direct current to the filter system 104. The power for the filter system 104 is provided to a printed circuit board 906 that provides for control of the components within the filter system 104 such as an ultraviolet light 908 through an ultraviolet ballast 910 and a fan 912.

The printed circuit board 906 includes a relay 914 for control of the ultraviolet ballast 910 and ultraviolet light 908. The printed circuit board 906 also includes a reed switch 916 for control of the fan 912 that provides for air movement through the filter system 104. The printed circuit board further includes a microcontroller unit 918 that provides control of the relay 914 and the reed switch 916 for operation of the filter system 104. The microcontroller unit 918 may receive signals from a user input device 920 as well as a reed switch 916 for enabling control of the filter system 104 as described with respect to the magnetic switch herein. The reed switch 916 may sense a magnet 924 positioned on the housing 102 that provides for detection of the filter system 104 being installed on the housing 102.

While the invention is described with respect to the specific embodiments, it is to be understood that the scope of the invention is not limited to these specific embodiments. Since other modifications and changes varied to fit particular operating requirements and environments will be apparent to those skilled in the art, the invention is not considered limited to the embodiments chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

1. A filter system for an enclosed pipette system within a housing, the filter system comprising:
a body having a first surface and a second surface opposite the first surface, the second surface being configured to engage with the housing of the enclosed pipette system, and the body including:
a first opening,
one or more second openings in an external surface of the body, and
a plenum defining a conduit between the one or more second openings and the first opening;
a mounting system positioned on the second surface and including a plurality of latches configured to releasably secure the body to the housing;
a filter component positioned within the plenum; and
an air movement system contained within the body and configured to force air through the plenum from the one or more second openings to the first opening.

2. The filter system of claim 1, wherein:
the filter component is positioned adjacent the first opening, and
the plenum includes:
a first plenum portion extending from the one or more second openings to a pre-filter chamber; and
a second plenum portion from the pre-filter chamber to the filter component.

3. The filter system of claim 2, wherein the air movement system is positioned downstream of the pre-filter chamber.

4. The filter system of claim 1, further comprising a switch at the second surface, the switch configured to:
detect a position of the body at a top edge of the housing, and
enable the air movement system when the filter system is coupled to the housing.

5. The filter system of claim 1, wherein the mounting system includes:
a receptacle extending from the second surface and defining a passage; and
a pin positioned within the passage and configured to move between a first position and a second position, wherein:
in the first position, a first end of the pin extends out of the passage in a first direction to engage with the housing, and
in the second position, the first end of the pin is within the passage.

6. The filter system of claim 1, further comprising an ultraviolet source positioned adjacent the second surface and configured to project ultraviolet light into the housing of the enclosed pipette system.

7. The filter system of claim 6, wherein the ultraviolet source includes an ultraviolet light bulb and a reflector positioned recessed within the second surface.

8. A filter system for a pipette system comprising:
a body having a first surface and a second surface opposite the first surface, the second surface being configured to engage with the pipette system, and the body including:
a first opening;
one or more second openings in an external surface of the body; and
a plenum defining a conduit between the one or more second openings and the first opening;
a mounting system positioned on the second surface and including a plurality of latches configured to releasably secure the body to the pipette system; and
an air movement system contained within the body and configured to force air through the plenum from the one or more second openings to the first opening.

9. The filter system of claim 8, wherein:
the one or more second openings include a releasable connection configured to receive a removable handle; and
the removable handle extends from an exterior wall when connected to the body and the one or more second openings are open for air flow into the body when the removable handle is disconnected from the body.

10. The filter system of claim 8, further comprising a filter component positioned within the plenum and configured to filter air moved by the air movement system to the first opening and into the pipette system, the filter component comprising a high efficiency particulate air (HEPA) filter.

11. The filter system of claim 8, further comprising a gasket positioned on the second surface surrounding the first opening, the gasket configured to provide an airtight seal between the body and the pipette system when the body is secured using the mounting system.

12. The pipette system of claim 8, further comprising a user interface positioned on the body, the user interface configured to receive a user input and provide a signal for control of the air movement system.

13. The pipette system of claim 8, further comprising a switch at the second surface, the switch configured to detect the body being positioned on the pipette system and enable operation of the air movement system when the filter system is coupled to the pipette system.

14. The pipette system of claim 8, further comprising a communication connection configured to enable a computing device of the pipette system to control operation of the air movement system.

15. An air handling unit for an enclosure comprising:
a body having a first surface and a second surface opposite the first surface, the second surface being configured to engage with the enclosure, and the body including:
a first opening;
one or more second openings; and
a plenum defining a conduit between the one or more second openings and the first opening;
a mounting system positioned on the second surface and configured to releasably secure the body to the enclosure; and
an air movement system contained within the plenum and configured to force air through the plenum from the one or more second openings to the first opening.

16. The air handling unit of claim 15, further comprising:
a pre-filter chamber within the plenum, the pre-filter chamber including a first filter component having a first open area; and
a second filter component positioned within the plenum downstream of the pre-filter chamber, the second filter component having a second open area smaller than the first open area.

17. The air handling unit of claim 16, wherein:
the second filter component is positioned adjacent the first opening; and
the second filter component comprises a high efficiency particulate air (HEPA) filter.

18. The air handling unit of claim 15, wherein the mounting system includes:
a receptacle extending from the second surface and defining a passage; and
a pin positioned within the passage and configured to move between a first position and a second position, wherein:
in the first position a first end of the pin extends out of the passage in a first direction to engage with the enclosure, and
in the second position the first end of the pin is within the passage.

19. The air handling unit of claim 15, further comprising an ultraviolet source positioned at the second surface and configured to project ultraviolet light into the enclosure.

20. The air handling unit of claim 19, wherein the ultraviolet source includes an ultraviolet bulb having a bent shape and a reflector positioned adjacent to and recessed within the second surface and configured to reflect ultraviolet light from the ultraviolet bulb across the enclosure.
